(19) United States
(12) Patent Application Publication
(10) Pub. No.: US 2024/0033682 A1
(43) Pub. Date: Feb. 1, 2024

(54) POLYMERIC MATERIALS FOR CARBON DIOXIDE CAPTURE

(71) Applicants: Matthew Green, Phoenix, AZ (US); Mani Modayil Korah, Tempe, AZ (US); Kyle Culp, Phoenix, AZ (US)

(72) Inventors: Matthew Green, Phoenix, AZ (US); Mani Modayil Korah, Tempe, AZ (US); Kyle Culp, Phoenix, AZ (US)

(21) Appl. No.: 18/361,657

(22) Filed: Jul. 28, 2023

Related U.S. Application Data
(60) Provisional application No. 63/392,989, filed on Jul. 28, 2022.

(51) Int. Cl. B01D 53/62; B01D 53/96; B01D 53/78; B01D 53/30; C08F 126/02; B01J 20/26; B01J 20/28; B01J 20/34

(52) U.S. Cl. CPC B01D 53/62; B01D 53/96; B01D 53/78; B01D 53/30; C08F 126/02; B01J 20/267; B01J 20/28016; B01J 20/28023; B01J 20/3425; B01J 20/3475; B01J 20/3483; B01J 20/3466; B01D 2257/504; B01D 2253/202; B01D 2259/40088; C08F 2810/20

(57) ABSTRACT

A carbon dioxide capture composition includes a hydroxide-ion-exchanged poly(N-vinyl guanidine)-based polymer material as a sorbent. A method of preparing the carbon dioxide capture composition includes contacting a poly(N-vinyl guanidine)-based polymer material with hydroxide ion exchange beads, and exchanging hydroxide ion into the poly(N-vinyl guanidine)-based polymer material to form the sorbent. A carbon dioxide capture method includes contacting the sorbent with a gas stream, and sorbing carbon dioxide in the gas stream with the sorbent. A carbon dioxide capture system includes a sorption bed having a hydroxide-ion-exchanged poly(N-vinyl guanidine)-based polymer material as a sorbent.

### CROSS-REFERENCE TO RELATED APPLICATION

This application claims the benefit of U.S. Patent Application No. 63/392,989 filed on Jul. 28, 2022, which is incorporated by reference herein in its entirety.

### STATEMENT OF GOVERNMENT INTEREST

This invention was made with government support under 80NSSC18K1508 awarded by the National Aeronautical & Space Administration. The government has certain rights in the invention.

### TECHNICAL FIELD

This invention relates to systems and methods for capture of carbon dioxide from a gas mixture.

### BACKGROUND

Direct air capture (DAC) is a technology that uses chemical media to remove carbon dioxide (CO₂) from ambient air. The process involves contacting air at ambient temperature and pressure with the chemical media, which selectively traps CO₂ while allowing other components of air to pass. The captured CO₂ can then be removed from the media and sequestered or used for industrial or agricultural purposes.

### SUMMARY

This disclosure describes methods and systems for capturing carbon dioxide (CO₂) directly from gas mixtures, including ambient air. The carbon dioxide capture is based on a sorbent including poly(N-vinyl guanidine)-based (PVG-based) polymer materials. The PVG-based polymer materials (or “PVG polymer”) show CO₂ sorption characteristics suitable for applications including direct air capture (DAC) of CO₂, removal of CO₂ from industrial exhaust gas streams, and removal of CO₂ from closed systems (e.g., space cabin environments).

In some embodiments, a solid form of the PVG polymer is used to capture CO₂ directly from the atmosphere. In some embodiments, the PVG polymer is dissolved in water to yield a solution suitable for CO₂ sorption. The PVG polymer can also be shaped into nanofiber sheets to increase surface area and thus sorption capability.

The PVG polymer becomes an active CO₂ sorbent after anion exchange with hydroxide. The PVG polymer can be regenerated for repeated use by heating the PVG polymer in air, passing the PVG polymer over hydroxide ion exchange beads, or both. These methods offer low energy regeneration routes and high CO₂ sorption capacities. PVG can be crosslinked to yield a sorbent compatible with steam regeneration.

In a first general aspect, a carbon dioxide capture method includes contacting a sorbent with a gas stream and sorbing carbon dioxide in the gas stream with the sorbent. The sorbent includes a hydroxide-ion-exchanged poly(N-vinyl guanidine)-based polymer material.

In a second general aspect, a carbon dioxide capture composition includes a hydroxide-ion-exchanged poly(N-vinyl guanidine)-based polymer material.

In a third general aspect, a method of preparing a carbon dioxide capture composition includes contacting a poly(N-vinyl guanidine)-based polymer material with hydroxide ion exchange beads, and exchanging hydroxide ion into the poly(N-vinyl guanidine)-based polymer material to form the carbon dioxide capture composition.

In a fourth general aspect, a carbon dioxide capture system includes a sorption bed including a sorbent. The sorbent includes a hydroxide-ion-exchanged poly(N-vinyl guanidine)-based polymer material.

Implementations of the fourth general aspect can include one or more of the following features. The carbon dioxide capture system can include a heater configured to heat the sorption bed, a sensor configured to assess a presence of carbon dioxide, a first conduit configured to provide an input gas to the sorption bed, and a second conduit configured to provide processed input gas from the sorption bed to the carbon dioxide analyzer.

### BRIEF DESCRIPTION OF DRAWINGS

FIG. 1 shows a reaction schematic for the synthesis of poly(vinyl guanidine).

FIG. 2 depicts glutaraldehyde crosslinking of poly(vinyl guanidine).

FIG. 3 is a schematic diagram of a three-bucket desorption system.

FIG. 4 is a schematic diagram of a liquid sorbent open circuit test system.

FIG. 5 is a DSC plot of various poly(vinyl guanidine) polymers.

FIG. 6 is a TGA plot of various poly(vinyl guanidine) polymers.

FIG. 7 shows FTIR plots of PVG, GA crosslinked PVG and PVG with various counterions.

FIG. 8 shows sorption performance of PVG in the closed circuit system after thermal regeneration at 100° C. for 30 min.

FIGS. 9A-9C show raw closed circuit CO₂ sorption data for GA-PVG 2 polymer for first cycle, second cycle low humidity start, and third cycle high humidity start, respectively.

FIG. 9D is a table summarizing sorption performance.

FIGS. 10A and 10B show open sorption performance of GA-PVG 2 after 30 min steam regeneration.

FIGS. 11A and 11B show raw data and cumulative sorption performance, respectively, of GA-PVG 3 in the open circuit system.

FIGS. 12A and 12B show first cycle cumulative sorption and raw data, respectively, of GA-PVG 2 in the closed circuit system at 4500 ppm simulated cabin air condition. The sample was desorbed for 10 min with steam prior to sorption testing.

FIGS. 13A and 13B show sorption performance of GA-PVG 2 during cycle 2. FIGS. 13C and 13D show sorption performance of GA-PVG 2 during cycle 3. The sample was desorbed for 10 min with steam prior to sorption testing.

FIG. 14 is a schematic diagram of an electrospinning apparatus for the production of PVG nanofibers.

FIGS. 15A and 15B show open circuit data (raw data and cumulative CO₂ adsorbed, respectively) of PVG. Testing was done after thermal regeneration at 100° C. for 30 min.

FIG. 16 shows sorption performance of DVB-PVG beads in the closed circuit system after 10 min of steam regeneration.

FIGS. 17A-17D show sorption performance of 5 wt % PVG liquid sorbent over cycles 1-4, respectively.

FIGS. 18A-18D show thermal vs pH swing desorption of PVG liquid sorbent.

### DETAILED DESCRIPTION

This disclosure describes methods and systems for capturing carbon dioxide (CO₂) directly from gas mixtures, including ambient air. The carbon dioxide capture is based on a sorbent including poly(N-vinyl guanidine)-based (PVG-based) polymer materials. The PVG polymer has a pKₐ of 13.4 (e.g., between 13 and 14) which is close to the guanidine molecule, making it a highly basic polymer. The PVG-based polymer materials (or “PVG polymer”) show CO₂ sorption characteristics suitable for applications including direct air capture (DAC) of CO₂, removal of CO₂ from industrial exhaust gas streams, and removal of CO₂ from closed systems (e.g., space cabin environments).

In some embodiments, a solid form of the PVG polymer is used to capture CO₂ directly from the atmosphere. The PVG polymer can be dissolved in water to yield a solution suitable for CO₂ sorption. The PVG polymer can also be shaped into nanofiber sheets to increase surface area and thus sorption capability.

The PVG polymer becomes an active CO₂ sorbent after anion exchange with hydroxide. The PVG polymer can be regenerated for repeated use by heating in air at 100° C. for 30 minutes. This method of regeneration offers a low energy regeneration route with the PVG polymer showing CO₂ sorption capacities close to 700 μmol/g in a span of 2 h when exposed to ambient air at high humidity. The PVG polymer can also be regenerated by contacting with hydroxide ion exchange beads. The PVG can be crosslinked to make it compatible with steam regeneration. The PVG polymer can also be shaped into nanofiber sheets to increase surface area and thus sorption capability.

In some embodiments, a carbon dioxide capture method includes contacting a sorbent with a gas stream and sorbing carbon dioxide in the gas stream with the sorbent. The sorbent includes a hydroxide-ion-exchanged poly(N-vinyl guanidine)-based polymer material.

In some embodiments, a carbon dioxide capture composition includes a hydroxide-ion-exchanged poly(N-vinyl guanidine)-based polymer material.

In some embodiments, preparing a carbon dioxide capture composition includes contacting a poly(N-vinyl guanidine)-based polymer material with hydroxide ion exchange material, and exchanging hydroxide ion into the poly(N-vinyl guanidine)-based polymer material to form the carbon dioxide capture composition.

In some embodiments, a carbon dioxide capture system includes a sorption bed including a sorbent. The carbon dioxide capture system can further include a heater configured to heat the sorption bed, a sensor configured to assess a presence of carbon dioxide, a first conduit configured to provide an input gas to the sorption bed, and a second conduit configured to provide processed input gas from the sorption bed to the carbon dioxide analyzer.

### EXAMPLES

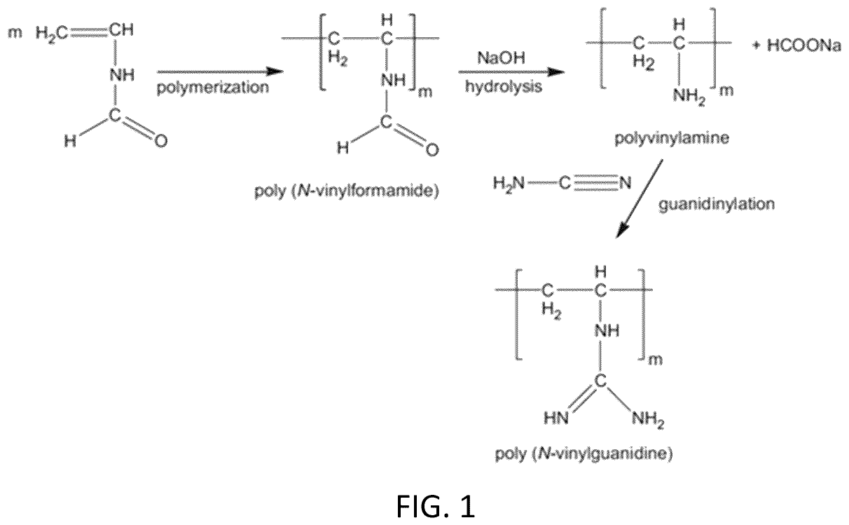

A synthesis of poly(N-vinyl guanidine) (PVG) is depicted in FIG. 1. In one example, 20 g N-vinyl formamide (NVF) was dissolved in deionized (DI) water (200 mL). 13 mg of AIBH, a water soluble initiator, was added and the system was purged with nitrogen for 30 minutes. The system was then brought to a temperature of 60° C., and the free radical polymerization was allowed to continue for 24 h. The obtained poly(N-vinylformamide) (PNVF) was precipitated in acetone and vacuum dried. ¹H-NMR was used to confirm the polymerization of NVF to PNVF. The target molecular weight (MW) was 180,000 kDa.

Polyvinylamine (PVAM) was obtained from PNVF via basic hydrolysis. A 10% solution of PNVF in DI water was made and a 2M 1.3 molar excess of NaOH solution was added. The reaction temperature was maintained at 75° C. and the system was kept under an inert atmosphere. The reaction was allowed to proceed for 24 hours, and the complete hydrolysis of PNVF to PVAM was confirmed using ¹H-NMR. The obtained polymer was precipitated in acetone, vacuum dried, redissolved in DI water, dialyzed against DI water using a molecular weight cut-off membrane (MWCO) of 3 kDa to remove sodium formate side product, and lyophilized using a freeze dryer. The removal of sodium formate was also confirmed using ¹H-NMR.

To obtain PVG, 6 g (140 mmol) of PVAM was dissolved in 200 mL DI water. 10 mL 37% HCl and 13.8 g (164 mmol) of 50% aqueous solution of cyanamide were then added, and the solution was kept at 90° C. for 24 h under constant stirring after N₂ purge for 30 minutes. The resulting polymer solution was precipitated in acetone, dried, redissolved in DI water, and dialyzed against DI water (MWCO, 1 kDa). After dialysis, the polymer solution was lyophilized. The chemical structure was confirmed using 1H-NMR after using D₂O solvent.

The synthesized polymer was then redissolved in DI water and passed through Marathon A beads with a hydroxide counterion, thereby promoting the exchange of chloride counterions to hydroxide. The polymer solution is tested for pH using a pH strip and the change in pH was noted to be from 2 to 12.

To obtain (trifluoromethanesulfonyl)imide (TFSI) counterion, a 10% PVG solution was stirred in a 1 M LiTFSI solution in water. The counterion exchange happened almost instantly and the polymer started to precipitate out of solution, since the solubility of [PVG][TFSI] is lower than [PVG][Cl] in water.

To obtain amino acid L-Arginine counterion, the PVG was passed through the Marathon A hydroxide exchange resin first to change the counterion to hydroxide. Addition of equimolar amounts of the amino acid into 10% PVG solution results in the formation of [PVG][L-Arg].

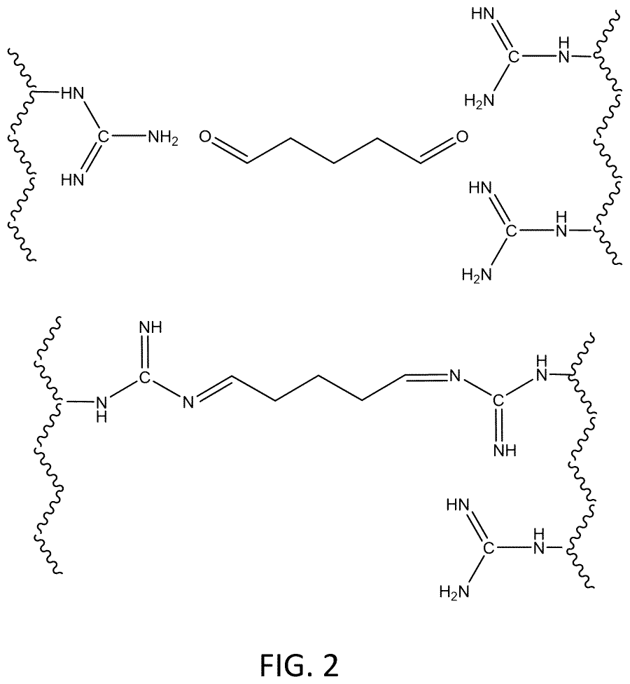

Glutaraldehyde crosslinking of PVG was achieved as follows. A 5 wt % solution of PVG in water was first made in a vial by dissolving 0.2 g of PVG in 3.8 g DI water. 25 wt % Glutaraldehyde (GA) was diluted to a 5 wt % stock GA solution. To make 13.3% crosslinked GA-PVG (GA-PVG 2), 13.3 molar equivalent or 31.3 mg of 5 wt % GA stock solution was added to the PVG solution. The vial was then placed on a vortex machine immediately after GA addition and allowed to vortex for 5 minutes. The polymer reacted with the GA almost immediately and started to form a gel like network. The vial was left to stir for an hour and later placed in an oven set to 100° C. to finish the crosslinking reaction and evaporate residual solvents. Similarly, polymers with various amounts of GA were made, namely 6.6, 13.3 and 26.6 mol % and labeled as GA-PVG 1, GA-PVG 2 and GA-PVG 3, respectively. FIG. 2 shows the crosslinking reaction between GA and PVG. Unlike conventional polymers, the reaction with a crosslinker does not deplete all the amine groups in the crosslinking reaction.

Divinylbenzene-poly(vinyl formamide) beads were synthesized as follows. Into a round bottom flask, 50 g of silicon oil with a viscosity of 1000 Pa·s was added. This was followed by the addition of 5 g of NVF, 1.5 g of DVB (molar ratio of NVF:DVB=10:1), 0.1196 g of AIBN (molar ratio of initiator to monomers 1:100) and 2 mL of DI water. The mixture was stirred with a mechanical stirrer at a rate of 400 RPM. The system was purged with N₂ for 30 min and allowed to polymerize at 60° C. for 6 h. The mixture was then poured into 1 L of toluene and the obtained beads were filtered off, rinsed with toluene and water, and vacuum dried. The loss of solvent during vacuum drying imparted porosity to the beads.

Divinylbenzene-poly(vinyl amine) beads were synthesized as follows. The beads obtained earlier were then put into a round bottom flask filled with 2 M 150 mL solution of NaOH. The contents of the flask was purged with N₂ for 30 min and then heated to 60° C. for 24 h under constant stirring. The suspension was then neutralized with a 2M solution of HCl and the beads were filtered off, rinsed with water, and vacuum dried.

Divinylbenzene-poly(vinyl guanidine) beads were synthesized as follows. 3 g of the dried DVB-PVAm beads were then transferred to another round bottom flask filled with 300 mL of DI water. This was followed by the addition of 6.5 g of cyanamide and 5 mL of 37 wt % HCl. The vessel was purged with nitrogen for 30 min and allowed to react at 90° C. for 24 h. The obtained beads were then filtered off, rinsed with water, and vacuum dried.

The dried DVB-PVG beads were then stirred for 24 hours in a 1 M 1 L solution of NaOH to change the anion counterion from chloride to hydroxide. This was followed by washing and stirring in pure DI water for 24 hours to remove excess NaOH. The beads were then vacuum dried and tested for sorption performance.

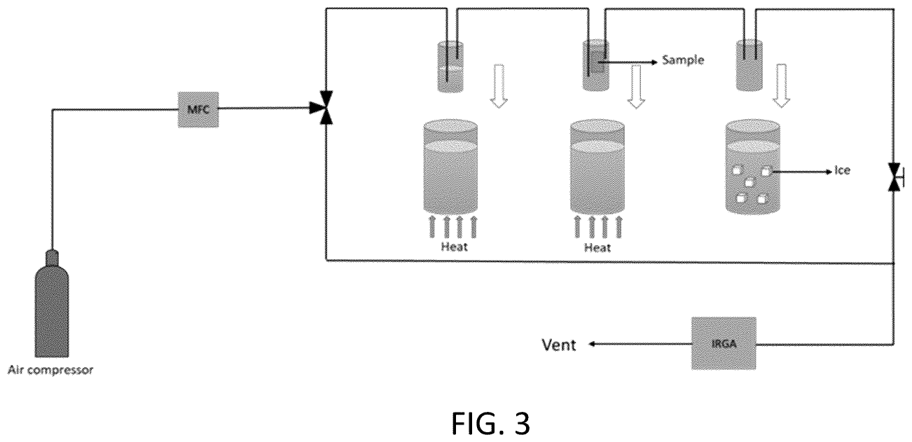

The performance of the synthesized materials was tested in the closed and open circuit systems. Prior to testing, the sample was subjected to thermal or steam regeneration. Unless specified, steam regeneration process involves exposing the sample to steam generated from boiling water in a 500 mL beaker. The three-bucket system depicted in FIG. 3 was used to measure desorption of the sample in real time when exposed to steam. The three-bucket system for regeneration system includes three sealed separate chambers and three “buckets” filled with either water or ice that serves as a water/ice bath to control temperature of their respective chambers. The first chamber is filled partially with water, which will serve as the source for steam. The sample is clamped to the middle of the second chamber. Finally, the third chamber serves as a cold trap to get rid of excess moisture before the air enters the IRGA. Excessive moisture and steam can damage the components in the IRGA. The temperature of the water baths for the first and second chambers can be controlled using a hot plate. Generally, the water in both chambers is set to 90-95° C. The gas used in the system is lab air, which is stored in a chamber using an air compressor. This ensures that the inlet air stream CO₂ concentration does not fluctuate based on environmental conditions. The air flow rate which is controlled by the mass flow controller is set to a flow rate of 0.5 L/min. During the start of the experiment, the 3-way valve is set to bypass the chambers, and the second valve is closed to isolate the chamber area and divert the air directly towards the IRGA. This allows for baseline CO₂ concentration measurement. Then the 3-way valve is set to flow towards the chambers and the second valve is set to open. The whole 3-chamber assembly is then lowered to their respective baths. The hot water bath of the first chamber causes water to heat up and the air carries the steam emitted over to the second chamber. The sample can thus be steamed at the set temperature of the second water bath. The desorbed CO₂ can then be measured in real time using an infrared gas analyzer (IRGA). After desorption, the second chamber can be isolated from the system and attached to the open circuit for sorption testing. The chamber is cooled in the ice bath prior to testing in the open circuit. The open circuit flow rate is set to 0.5 L/min.

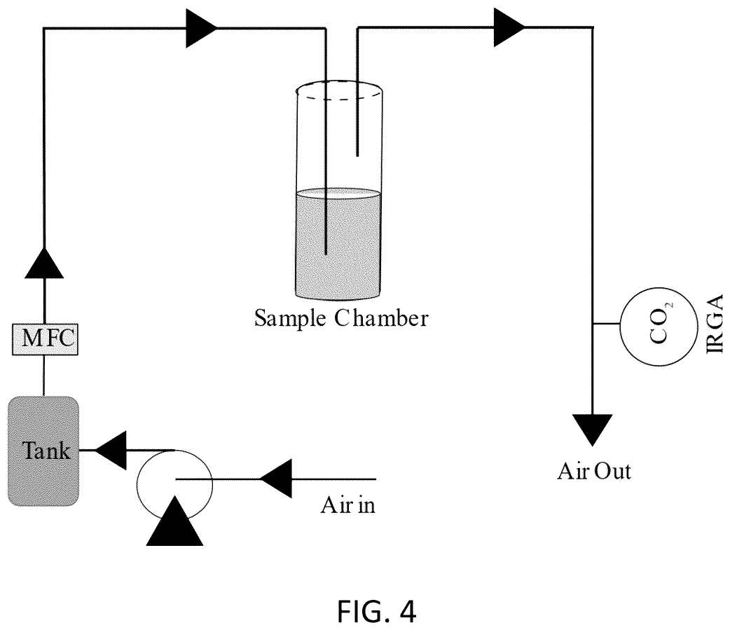

Liquid PVG was tested using the system shown in FIG. 4. The test system is similar to the open circuit system apart from the test chamber. The test chamber for the liquid test system includes a cylindrical chamber, in which air that is stored in the tank can be bubbled at a fixed flow rate through the liquid sorbent using a mass flow controller. The amount of CO₂ that the liquid sorbent absorbs can be recorded in real time using the IRGA. Thermal swing desorption can be tested on the same device by immersing the sample chamber in a heated water bath.

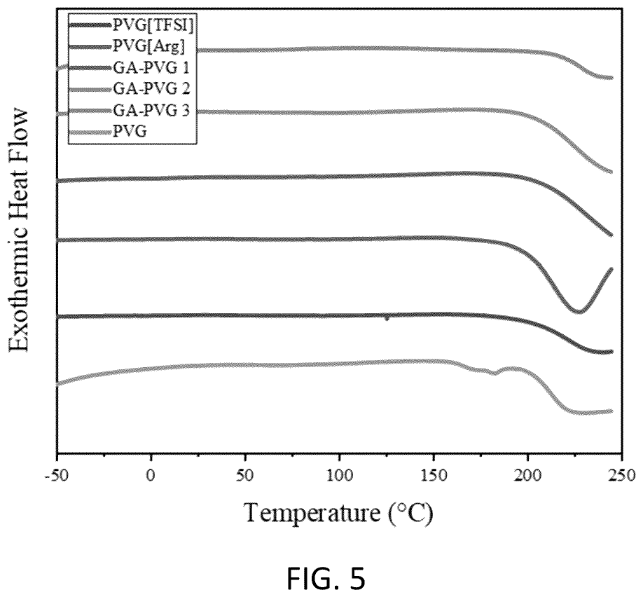

A DSC plot of the obtained PVG polymers including different counterions and degree of crosslinking is shown in FIG. 5. The plots, top to bottom, refer to GA-PVG 3, GA-PVG 2, GA-PVG 1, PVG[Arg], PVG[TFSI], and PVG. The glass transition temperature (T_{g}) of PVG was found to be at 165° C., which is close to its onset degradation temperature (T_{d}) of 160° C. Since T_{g} and T_{d} are close, interpretation of thermal data becomes difficult. The melting peak (Tₘ) is higher than the T_{d} of PVG polymer. The melting peak is more apparent on ion-exchanged PVG polymer with TFSI and arginine counterions, which have slightly higher thermal stability. From the DSC plot it is clear that increasing the concentration of the crosslinker shifts the T_{g} to higher temperatures, with the GA-PVG 3 showing the highest shift in T_{g} from 165° C. to 225° C.

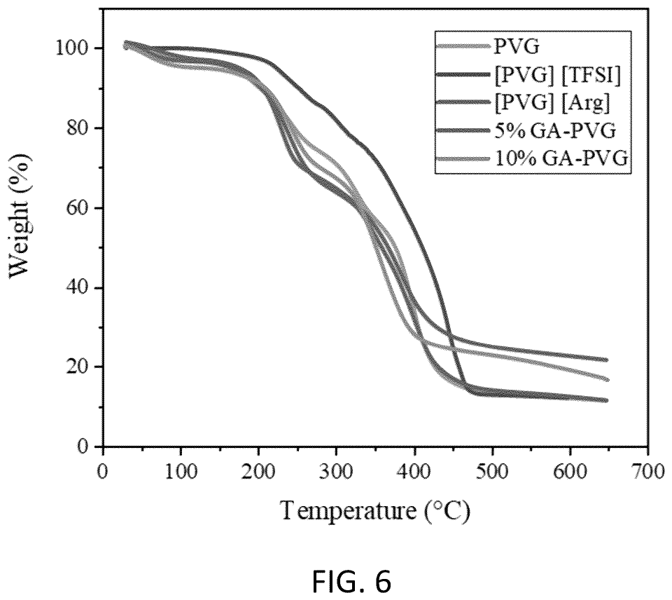

The TGA plot in FIG. 6 shows that the stability of the polymer depends on the counter ion. The plots, top to bottom in the lower right hand corner, refer to PVG[Arg], 10% GA-PVG, 5% GA-PVG, PVG, and PVG[TFSI]. Though TFSI counter ion offers no sorption capability, it significantly improves thermal stability. An L-Arg counterion did not significantly change thermal transitions but effected the amount of final residue. Increase in crosslinking, slightly shifted the onset of the first and second thermal transitions and also increased mass of final residue.

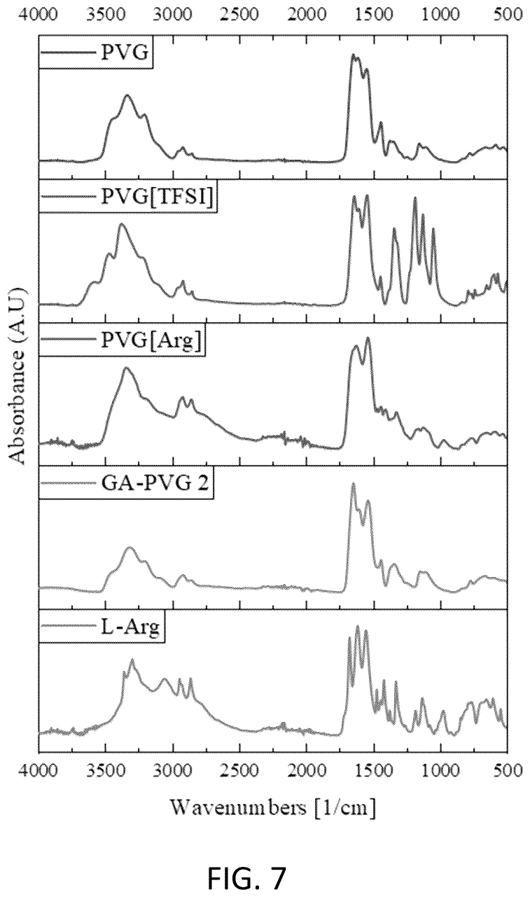

The FTIR plots in FIG. 7 show that both the TFSI and Arg has been incorporated into the polymer material. L-Arg peaks 2920 cm⁻¹ and 2850 cm⁻¹ show L-Arg incorporation. The amine peak becomes broader from 2500-3700 cm⁻¹ after L-Arg incorporation. After GA crosslinking, the PVG peak that corresponds to N—H, NH₂ deformation at 1647 cm⁻¹ becomes increases in intensity. The peak at 1550 cm⁻¹ that corresponds to C—N stretching also moves to 1530 cm⁻¹.

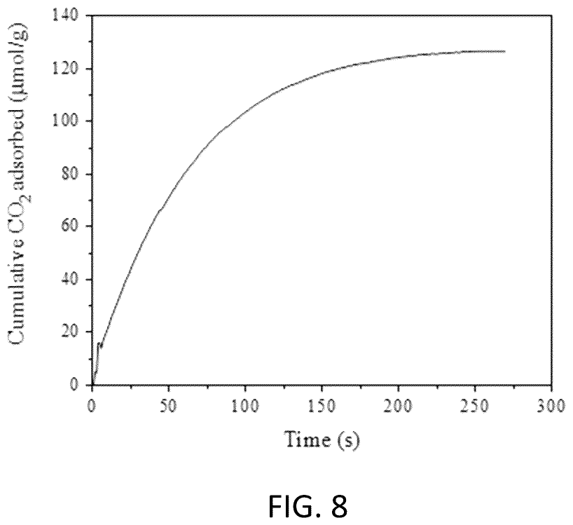

FIG. 8 shows sorption performance of PVG in the closed circuit system after thermal regeneration at 100° C. for 30 min. The synthesized PVG after anion exchange with hydroxide is tested for sorption performance in the closed-circuit system. The polymer displayed a sorption capacity of 126 μmol g⁻¹ and was able to reach equilibrium in a span of 250 min. This showed that the polymer had high sorption capacity and fast kinetics. Testing was done in 80% RH air and the sample was thermally regenerated in an oven for 30 minutes at 100° C. The PVG samples without hydroxide counterion exchange showed no CO₂ uptake. Since the PVG samples are water soluble, the polymer was crosslinked using GA, to make the polymer resistant to water and to utilize steam for regeneration.

The GA crosslinked PVG samples were also tested for sorption performance. GA-PVG 1 was noted to swell and slowly dissolve in hot steam. However, GA-PVG 2 and GA-PVG 3 were more resistant. GA-PVG 2 lost 40% of its mass after steam exposure, but the mass remained constant after initial exposure to hot water or steam. GA-PVG 3 lost 25% of its mass after initial steam/hot water exposure.

The GA-PVG 2 sample was first tested for sorption performance in the closed circuit system. It was noted that the rate of sorption was slower for the GA-PVG 2 sample when compared to PVG. However, the sorption capacity was comparable (131 μmol g⁻¹). The GA-PVG was also tested for 3 cycles of sorption and desorption to investigate its cycling performance. The samples were desorbed using steam for 10 minutes, using the set-up described earlier, which includes a heated beaker filled with the sample resting on the top.

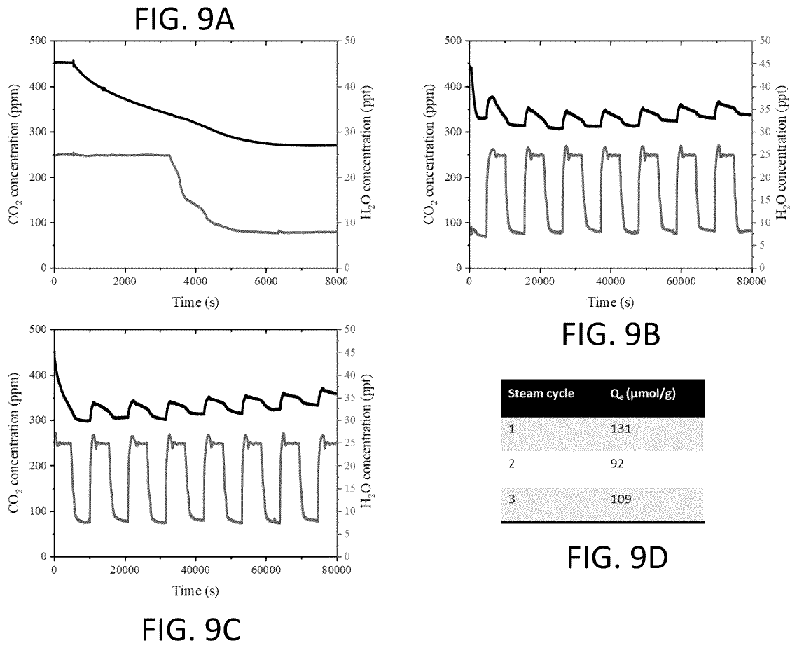

FIGS. 9A-9C show that the GA-PVG 2 samples have good cycling performance, which remains fairly consistent over three cycles. The second and third cycles also included humidity cycles to study if the material had moisture swing sorption properties. It was hypothesized that the sorption of CO₂ occurs when it reacts with the amine groups as opposed to the hydroxide group in moisture swing materials. The basic hydroxide group helps in hydrogen abstraction to deprotonate the amine groups, thereby helping with CO₂ sorption. This hypothesis is further confirmed by the fact that anion exchange to basic Arginine counterion also showed good CO₂ sorption, whereas TFSI and Cl counterion showed no sorption. There, it is believed that a basic counterion may be needed for CO₂ sorption.

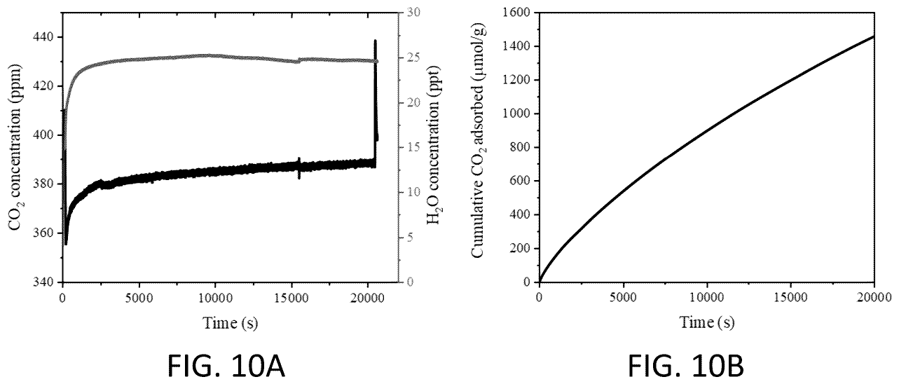

The GA-PVG 2 polymers were also tested for sorption performance in the open circuit system described earlier. The GA-PVG 2 polymer showed excellent sorption capacity and kinetics. The material was able to uptake 703 μmol g⁻¹ of CO₂ over a period of 2 h. The sorbent capacity was greater than 1 mmol g⁻¹ when exposed to lab air for greater than 3 h. The sorption performance is shown in FIGS. 10A and 10B. FIG. 10A shows results from GA-PVG 2 tested for steam desorption measured in the triple bucket system. FIG. 10B shows adsorption measured in the open system. The desorption capacity equals adsorption capacity. The performance is significant considering that the morphology of the material has not yet being optimized to have high surface areas. The performance can be expected to be improved further by increasing the surface area of contact with CO₂ from air. The relative humidity of incoming air is set to 60%.

The GA-PVG 2 polymer was then tested in the three bucket system to study desorption. FIGS. 10A and 10B show that the desorption performance of the sorbent is excellent. The polymer releases 588 μmol/g of CO₂ within a span of 41 minutes. Soon after desorption, the sample chamber is quenched in ice to stop the desorption process and later tested in the open circuit. The sample was able to uptake about 600 μmol/g in a span of 5.5 hours. The 4 h dynamic capacity was noted to be 525 μmol/g. Thus, the amount of CO₂ desorbed in the three bucket equals the amount adsorbed in the open circuit.

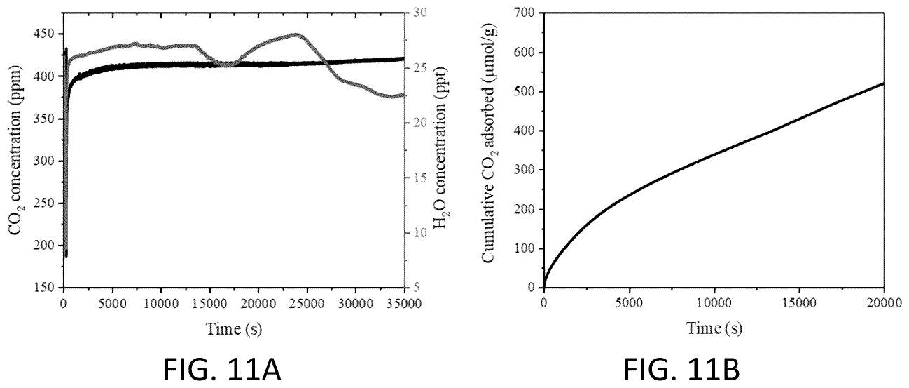

The effect of further crosslinking with GA was tested using the GA-PVG 3 polymer in the open circuit. FIGS. 11A and 11B show that the sorption capacity of GA-PVG 3 is lower than GA-PVG 2. This is expected since more guanidine groups are consumed during crosslinking with additional GA molecules. However, it was noted that the material had a good 4 h dynamic sorption capacity of 411 μmol/g.

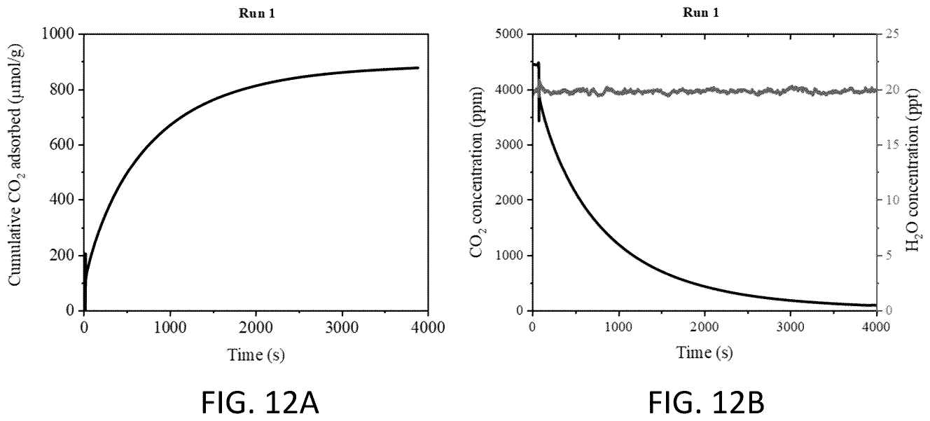

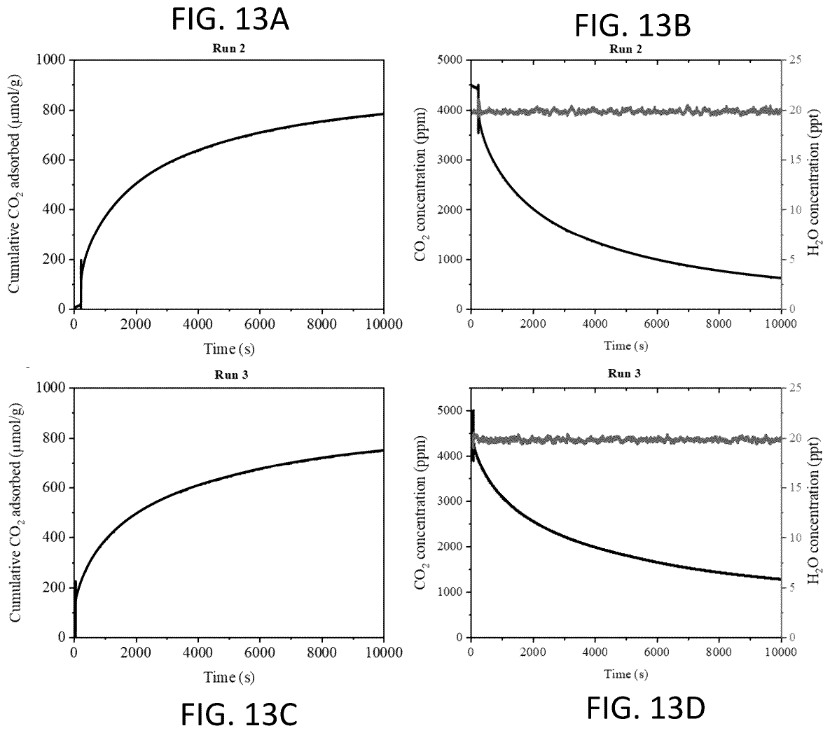

GA-PVG 2 was also tested for sorption performance under higher partial pressures of CO₂ in the closed circuit test system. When the inlet CO₂ concentration is increased to 4500 ppm, to simulate cabin air conditions in space, the sorption capacity increases to approximately 875 μmol g⁻¹ as shown in FIGS. 12A and 12B. Testing was performed over 2 cycles and the sorption performance is shown in FIGS. 13A and 13B (2 cycles) and FIGS. 13C and 13D (3 cycles). The second and third cycles show that the GA-PVG 2 polymer is capable of adsorbing around 800 μmol/g consistently over 3 cycles. However, the sorption time increased from 1 h to 2.7 h for the subsequent cycles. All testing was done at 80% RH and after 10 min of steam desorption.

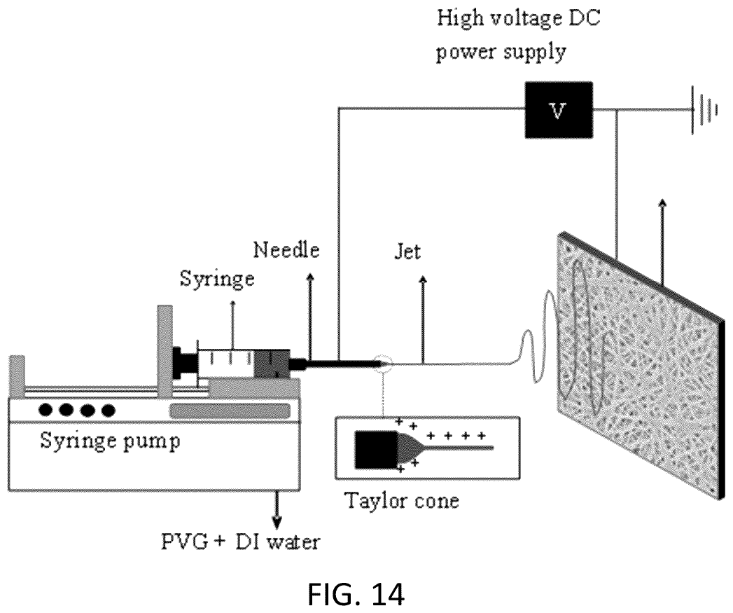

To improve the surface area of PVG, electrospinning was used to create nanofiber morphologies. Since initial electrospinning runs with low molecular weight PVG yielded poor fibers, the molecular weight was increased to improve the viscosity of the spinning solution. Triton X-100 surfactant is added to reduce surface tension of the polymer solution and facilitate good nanofiber formation. The electrospinning schematic is shown in FIG. 14. The electrospun fibers were uniform and had excellent macroscale structure.

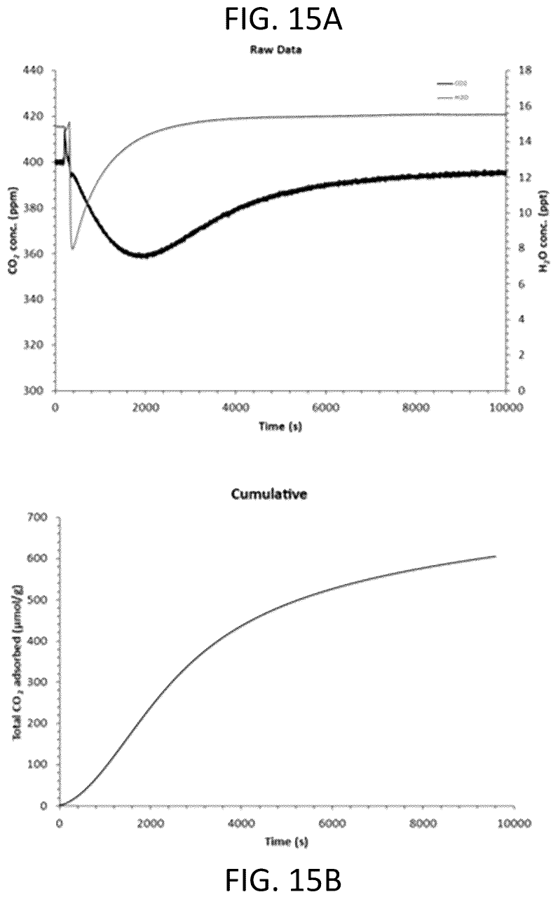

The nanofibers were peeled off the collector and then tested for sorption performance in the open circuit system. The data is shown in FIGS. 15A and 15B. The nanofibers can uptake 531 μmol g⁻¹ of CO₂ in a span of 2 h. From the data, it can be observed that the PVG nanofiber takes a while to reach peak sorption capacity. This is believed to be due to the delay during which moisture seeps into the nanofibers. Since moisture is required for sorption, the peak sorption rate peaks at around 2000 s. The curve equilibrates at around 600 μmol g⁻¹.

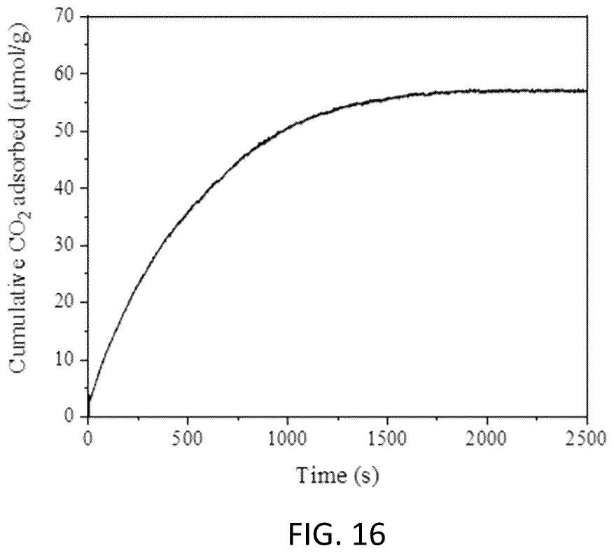

DVB-PVG beads were prepared using methods described herein. It is hypothesized that the circular spheres would improve surface area of contact of the PVG with CO₂ in the air and improve amine availability. Moreover, the beads appear to be porous due to the evaporation of solvent during freeze drying. Crosslinking with DVB also makes the beads non soluble in water and suitable steam regeneration. The sorption performance of the beads in the closed circuit system is shown in FIG. 16. The DVB-PVG beads adsorbed 55 μmol/g of CO₂ in a span of 30 minutes after 10 minutes of steam regeneration.

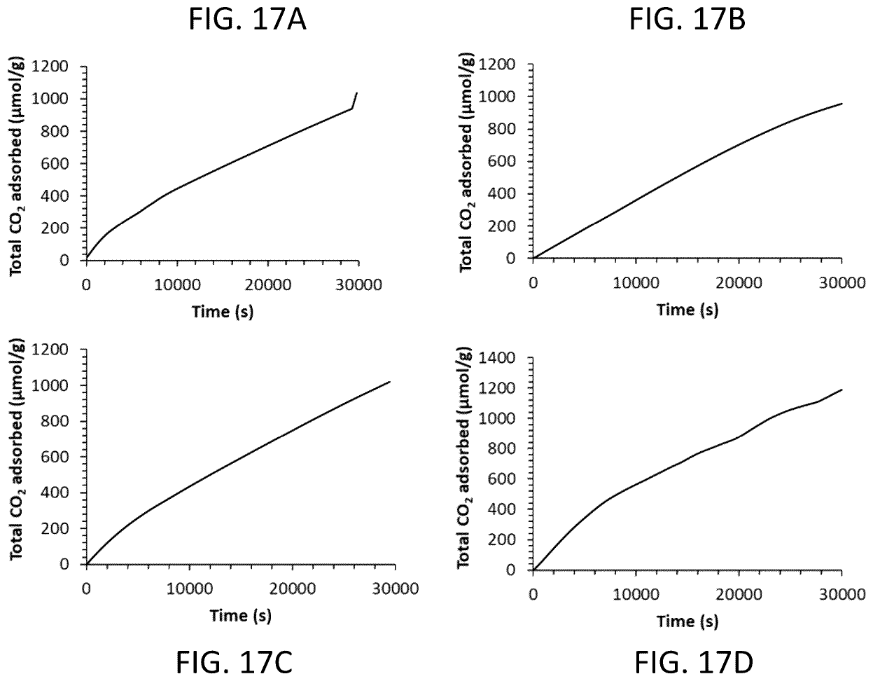

The performance of liquid PVG as a DAC sorbent was shown as follows. 0.7 g of PVG was dissolved in DI water to obtain a 5 wt % solution of PVG liquid sorbent. The liquid polymer solution obtained was filled into the sample chamber of the liquid sorbent testing chamber and air was bubbled through the sorbent at a flow rate of 0.5 L/min. The performance of the liquid sorbent over 4 cycles is shown in FIGS. 17A-17D. When air was bubbled through a 5% PVG solution the capacity of the polymer was shown to be up to 4400 μmol/g (weight with respect to PVG polymer).

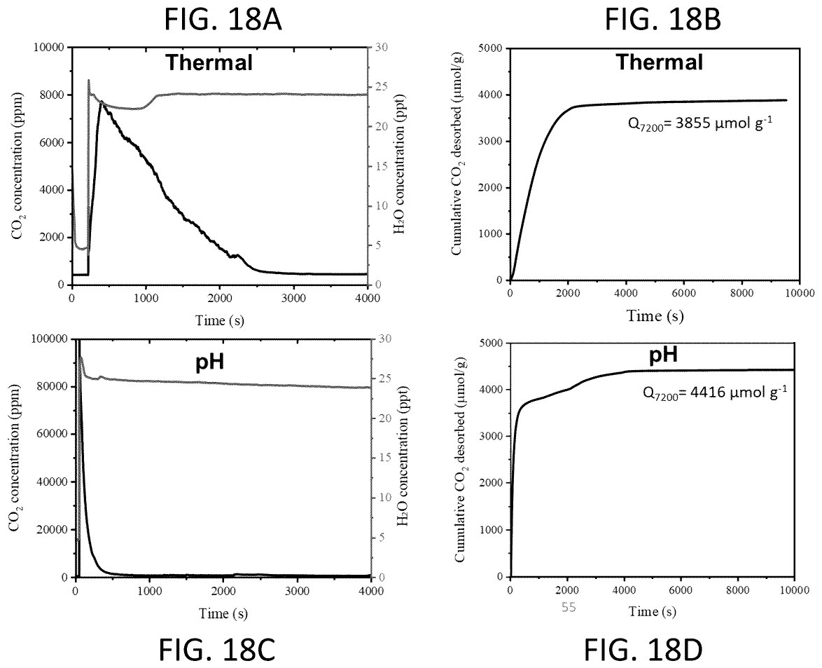

Desorption for cycles 1-3 was performed by heating the sample chamber in a water bath after the sorption cycle. Desorption before the last cycle 4, was done by a pH swing. 5 mL of 0.5 M HCl was added to the liquid sorbent sample chamber and the desorption was immediately measured. Rigorous effervescence was observed upon HCl addition. After desorption, the sample was passed through a column filled with Amberlite OH⁻ resin to exchange the Cl⁻ counterions to OH⁻. The desorption plot comparing thermal and pH swings on PVG liquid sorbent is shown in FIGS. 18A-18D. The pH swing was noted to release most of the absorbed CO₂ within a span of 500 s, whereas thermal regeneration took around 2500 s to desorb. Since equilibrium was not achieved in the open flow liquid test units, due to limitations of air tank capacity. The desorbed CO₂ was used to calculate the capacity of the liquid sorbent. The pH desorption cycle showed that the PVG liquid had a CO₂ sorption capacity of 4416 μmol per gram of dissolved polymer. While thermal swing consumes heat energy for desorption, pH swing consumes raw materials (i.e. acid and ions from ion exchange resin).

In summary, the use of poly(vinyl guanidine) polymers as a DAC sorbent has been demonstrated. The surface area and kinetics of sorption of the PVG can be improved by electrospinning the PVG into nanofibers. Furthermore, PVG can be crosslinked with GA to make it water and steam resistant. GA-PVG has been shown to have good cycling capacity over three steam regeneration cycles. GA-PVG was also shown to have excellent sorption capacity under space cabin air conditions. Finally, the potential of PVG to be used as a liquid sorbent was demonstrated over multiple cycles. Both thermal and pH swings were demonstrated for liquid PVG. The best performing guanidine polymeric sorbents achieved capacities of over 1 mmol g⁻¹.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A carbon dioxide capture composition comprising:
a hydroxide-ion-exchanged poly(N-vinyl guanidine)-based polymer material.

2. The carbon dioxide capture composition of claim 1, wherein the hydroxide-ion-exchanged poly(N-vinyl guanidine)-based polymer material is in the form of beads.

3. The carbon dioxide capture composition of claim 1, wherein the hydroxide-ion-exchanged poly(N-vinyl guanidine)-based polymer material is in the form of nanofibers.

4. The carbon dioxide capture composition of claim 1, wherein the hydroxide-ion-exchanged poly(N-vinyl guanidine)-based polymer material is crosslinked with glutaraldehyde.

5. The carbon dioxide capture composition of claim 1, wherein the hydroxide-ion-exchanged poly(N-vinyl guanidine)-based polymer material is water- and steam-resistant.

6. The carbon dioxide capture composition of claim 1, wherein the composition is a solution comprising the hydroxide-ion-exchanged poly(N-vinyl guanidine)-based polymer material.

7. The carbon dioxide capture composition of claim 6, wherein a pH of the solution is in a range of 2-12.

8. The carbon dioxide capture composition of claim 6, wherein composition comprises about 1 wt % to about 10 wt % of the hydroxide-ion-exchanged poly(N-vinyl guanidine)-based polymer material.

9. A carbon dioxide capture method comprising:
contacting a sorbent with a gas stream; and
sorbing carbon dioxide in the gas stream with the sorbent, wherein the sorbent comprises the carbon dioxide capture composition of claim 1.

10. The carbon dioxide capture method of claim 9, further comprising desorbing the carbon dioxide from the sorbent.

11. The carbon dioxide capture method of claim 10, wherein the sorbent is dissolved in an aqueous solution.

12. The carbon dioxide capture method of claim 10, wherein desorbing the carbon dioxide from the sorbent comprises a pH swing.

13. The carbon dioxide capture method of claim 12, wherein the pH swing comprises providing an acid to the aqueous solution.

14. The carbon dioxide capture method of claim 10, wherein desorbing the carbon dioxide from the sorbent comprises a thermal swing.

15. The carbon dioxide capture method of claim 10, wherein desorbing the carbon dioxide from the sorbent comprises steam regeneration.

16. A method of preparing a carbon dioxide capture composition, the method comprising:
contacting the poly(N-vinyl guanidine)-based polymer material with a medium comprising hydroxide ions; and
exchanging the hydroxide ions into the poly(N-vinyl guanidine)-based polymer material to form the carbon dioxide capture composition of claim 1.

17. The method of claim 16, wherein the contacting comprises contacting the poly(N-vinyl guanidine)-based polymer material with hydroxide ion exchange resin.

18. The method of claim 17, wherein the contacting initiates exchange of chloride counterions with hydroxide counterions.

19. A carbon dioxide capture system comprising:
a sorption bed comprising a sorbent, wherein the sorbent comprises a hydroxide-ion-exchanged poly(N-vinyl guanidine)-based polymer material.

20. The system of claim 19, further comprising:
a heater configured to heat the sorption bed;
a sensor configured to assess a presence of carbon dioxide;
a first conduit configured to provide an input gas to the sorption bed; and
a second conduit configured to provide processed input gas from the sorption bed to the carbon dioxide analyzer.
